(19) United States
(12) Patent Application Publication
(10) Pub. No.: US 2015/0140277 A1
(43) Pub. Date: May 21, 2015

(54) ANTI-SCATTERING STRUCTURE

(71) Applicant: Silitech Technology Corporation, New Taipei (TW)

(72) Inventors: CHIEN-CHIA CHEN, NEW TAIPEI (TW); JEN-CHIEN HUANG, NEW TAIPEI (TW); WEI-YUAN CHENG, NEW TAIPEI (TW)

(73) Assignee: SILITECH TECHNOLOGY CORPORATION, NEW TAIPEI (TW)

(21) Appl. No.: 14/154,990

(22) Filed: Jan. 14, 2014

(30) Foreign Application Priority Data
Nov. 15, 2013 (TW) 102221356

(51) Int. Cl. C09D 175/02

(52) U.S. Cl. CPC C09D 175/02
USPC 428/174; 524/612; 428/523; 428/522; 428/446; 428/704

(57) ABSTRACT

An anti-scattering structure which comprises a substrate having a first surface; and a polymer layer of a urea as an anti-scattering layer.

### RELATED APPLICATIONS

This application claims priority to Taiwan Application Serial Number 102221356, filed Nov. 15, 2013, which is incorporated by reference herein in its entirety.

### TECHNICAL FIELD

The present invention relates to an anti-scattering structure for a silicon-based substrate which is adaptive to the surface with irregular shape.

### BACKGROUND

The conventional way to achieve the anti-scattering feature is to laminate an anti-scattering film on the substrate. Please refer to FIG. 1; it depicts a side view of a conventional anti-scattering film laminated to a glass 10 with a flat surface. The anti-scattering film consists of two layers, the film layer 12 and a PSA (pressure sensitive adhesive) layer 11 which forms bonds when a pressure is applied to the adhesive; i.e. when the laminated glass surface 10 is bearing an impact force, the PSA layer 11 receives a pressure and a bond is formed so the glass fragment is held by the viscosity of the PSA. No solvent, water, or heat is needed to activate such an adhesive.

The conventional method of manufacturing the anti-scattering film is by roll-to-roll processing as shown in FIG. 2. It is a process of applying coatings, printing, or performing other processes starting with a roll of a flexible material and re-reeling after the process to create an output roll. After the base film is coated with a layer of PSA, it is normally slit to its finished size on a slitter re-winder. This outputted product needs to be stored in an autoclave with a constant pressure. Then the film is transported to the factory to cut into appropriate size to laminate the target object, e.g. mobile phone covers, watch covers, touch panels, windows and various products. Normally, such an anti-scattering structure has a thickness over 100 μm.

The cost of the aforementioned way to laminate a substrate is high because of the cost of the anti-scattering film is not able to reduce effectively due to certain processes need to be incorporated. It is not convenient to store and to transport the anti-scattering film as the film needs to be stored in the autoclave with monitored pressure. The defect rate is high as it is harder to laminate the substrate properly when the substrate is not flat. As shown in FIG. 3, void spaces or air bubbles 33 can be inspected around the curvatures or the corners when a conventional anti-scattering film is laminated on a substrate 30 with an uneven surface. The film layer 32 require a certain degrees of rigidity so it is able to provide a surface for the PSA layer 31 to be applied on but such rigidity has limited the applicability of such film on an uneven or curved surface. Furthermore, the thickness of such film is a restriction to further slim down the design of the product, particularly the products with precision electronics design.

Various patents and technologies have been published to propose different structures for anti-scattering glasses or anti-scattering film. These proposals, however, only provide partial solutions to the problems, so they have not become practical. For example, TW. Patent Application No. 99123505 discloses a flat substrate for flatting a first optical adhesive material thereon, then curing the first optical adhesive material as the hardness layer. After the hardness layer is formed, another layer of optical adhesive material is coated, following by another curing process to form an anti-scattering structure. The laminated substrate needs to be flat so the optical adhesive can be flattened to form a flat hardness layer after a full curing or pre-curing.

Other anti-scattering structures are illustrated in TW. Patent No. M433,951 discloses an anti-scattering film to adhere on the glass by users in a D.I.Y. manner, the film proposed is way too thick for the precision electronics design; M378,831 discloses an anti-scattering structure by stacking Calcium Silicate boards, PVC film, fabrics between glasses, such structure is way too bulky to be implemented to have a slim design.

The above mentioned inventions do not provide an overall solution and structure to the aforementioned problems. Hence, there is a need to solve these issues.

### SUMMARY

In this disclosure, a few embodiments are revealed. Firstly, an anti-scattering structure which comprises a layer of a urea polymer formed on a substrate. The substrate is made of any silicon-based material regardless of surface geometric contour and transparency level, i.e. the coating surface has a geometric shape selected from a group consisting of a flat shape, a curved shape, an uneven shape, an irregular shape, an engraved shape and a combination thereof. The substrate is opaque, translucent or transparent. The way to apply the coating material on the substrate is done via spray coating, slot die coating, immersion coating, curtain coating, air knife coating and a combination thereof. Following by thermal curing or ultraviolet curing to make the urea polymer layer hardened, forming an anti-scattering film. The said polymer is a waterborne polymer, a solvent-based polymer and a combination thereof.

Optionally, an ink layer formed on at least one of the surfaces of the substrate by spray printing, screen printing, transfer printing, inkjet printing, plating and a combination thereof between the substrate and the anti-scattering film. The type of ink could be a Polyvinyl Chloride-based ink, an Acrylonitrile Butadiene Styrene-based ink, an Acrylic-based ink and a combination thereof. There is no requirement of the opacity of the ink, i.e. the ink could be an opaque, translucent or transparent ink. The next step is to coat a layer of polymer which has a urea chain in its molecular structure as the anti-scattering layer formed on the surface of the ink layer. The ways to coat the anti-scattering layer on the ink layer is done via spray coating, slot die coating, immersion coating, curtain coating, air knife coating and a combination thereof. Following by a thermal curing or an ultraviolet curing to make the urea polymer layer hardened, forming an anti-scattering film. The polymer is a waterborne polymer, a solvent-based polymer and a combination thereof.

The anti-scattering structure can also stack up repeatedly into a multiple anti-scattering layers structure. An anti-scattering laminated structure comprises of a plurality of coating layers. Each of the coating layers comprises a substrate and a urea polymer layer as an anti-scattering film coated on the substrate.

### DESCRIPTION OF THE DRAWINGS

FIG. 1 is a schematic diagram illustrating a side view of a conventional anti-scattering film laminated to a substrate with a flat surface.

FIG. 2 is a schematic diagram illustrating the conventional roll-to-roll process for manufacturing an anti-scattering film.

FIG. 3 is a schematic diagram illustrating side view of a conventional anti-scattering film laminated to a substrate with curved surface.

FIG. 4 is shows a urea chain in a polymer.

FIG. 5a is a schematic diagram illustrating a 0.8 mm glass laminated with a conventional anti-scattering film after a free-fall test.

FIG. 5b is a schematic diagram illustrating a 0.8 mm glass with an anti-scattering structure according to the present invention after a free-fall test.

FIG. 6a is a schematic diagram illustrating the first embodiment in accordance with the present invention.

FIG. 6b is a schematic diagram illustrating the possible application of the first embodiment in accordance with the present invention.

FIG. 6c is a schematic diagram illustrating a possible application of the first embodiment in accordance with the present invention.

FIG. 7 is a schematic diagram illustrating the second embodiment in accordance with the present invention.

FIG. 8 is a schematic diagram illustrating the third embodiment in accordance with the present invention.

FIG. 9 is a schematic diagram illustrating the fourth embodiment in accordance with the present invention.

FIG. 10 is a schematic diagram illustrating the fifth embodiment in accordance with the present invention.

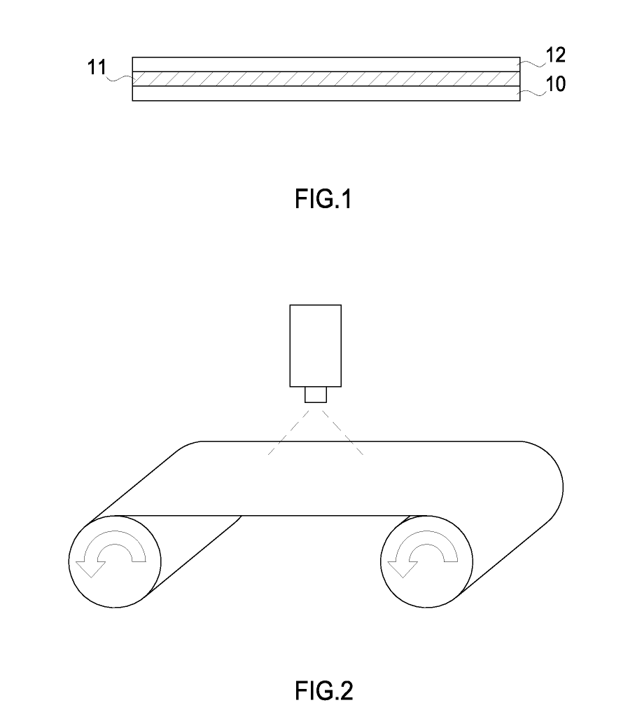

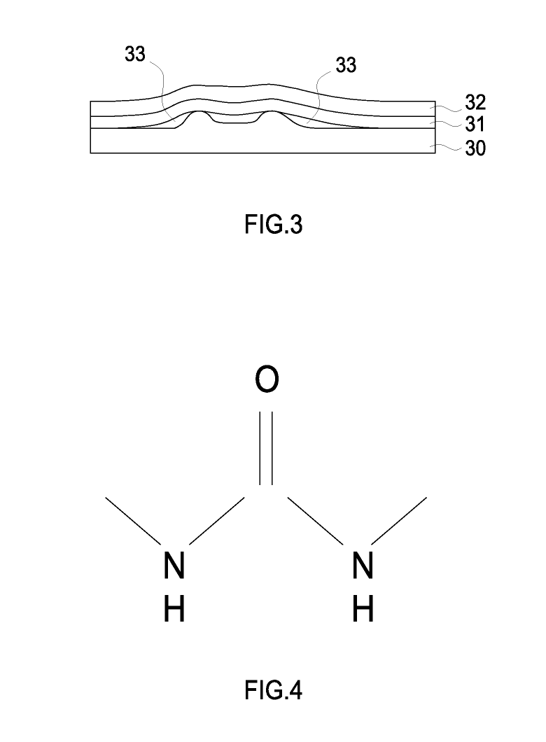

### DETAILED DESCRIPTION

The present disclosure will be described with respect to particular embodiments and with reference to certain drawings, but the disclosure is not limited thereto but it only limited by the claims. The drawings described are only schematic and are non-limiting. In the drawings, the size of some of the elements may be exaggerated and not drawn according to scale for illustrative purposes. The dimensions and the relative dimensions do not necessarily correspond to actual implementation in practice.

It is to be noticed that the term “including” used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof.

The substrate of the present invention is preferably, but not limited to, any silicate-based material including one of a Fused silica substrate, vitreous silica substrate,

Soda-lime-silica substrate, Sodium borosilicate substrate, Lead-oxide substrate, crystal substrate, Aluminosilicate substrate and the like. There is no restriction to the surface texture and geometric shape of such a substrate.

The way of coating with the mentioned polymer is preferably, but not limited to wet coating methods such as spray coating, slot-die coating, immersion coating, curtain coating, air-knife coating and a combination thereof to obtain the anti-scattering film. The polymer is a thermosetting polymer. Therefore, the substrate with the anti-scattering film has to have on-line curing in order to obtain the anti-scattering structure. The curing method is preferably, but not limited to thermal curing, ultra-violet light curing and a combination thereof. The polymer is also an elastomer;

therefore, it is provided an additional function as a waterproofing structure. The said polymer exhibits relatively high physical properties, particularly tensile strength and/or tear strength.

The anti-scattering film possesses the following optical properties: the transmittance rate is over 90% and the refractive index is 1.48˜1.61. A test about the proposed anti-scattering structure is conducted by measuring the impact lose rate. A 67 g steel ball is free-falling from lm above the test object. The impact lose rate is measured by calculating the weight of the test object after the impact over the weight of the test object before the impact.

$$impact lose rate = \frac{weight after impact}{weight before impact}$$

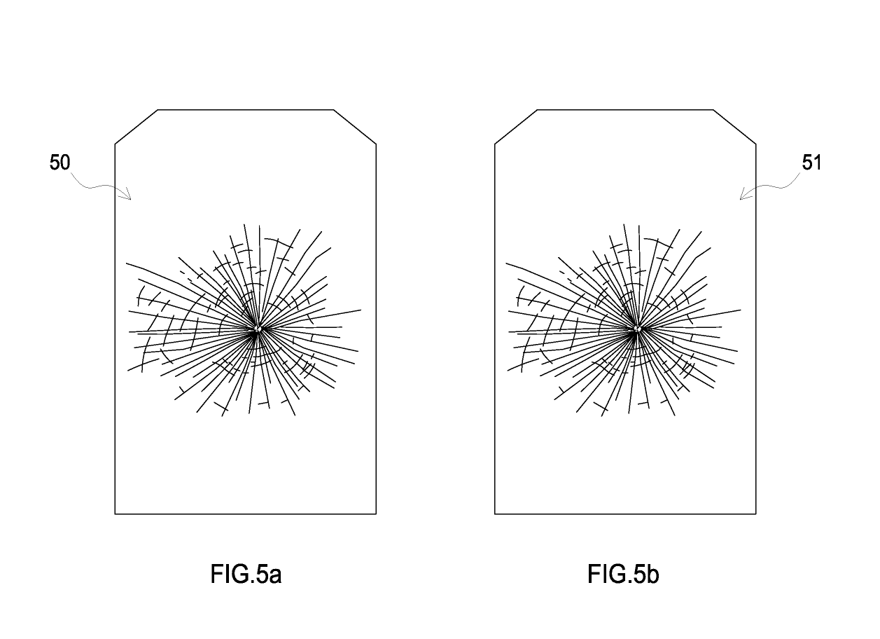

The measured impact lose rate of the proposed anti-scattering structure is less than 1%, which is the same as a test object laminated with the conventional anti-scattering film. The illustrations of the two objects after the free fall test are shown in FIGS. 5a and 5b whereas test object 50 is laminated with the conventional anti-scattering film and test object 51 is with the proposed anti-scattering structure.

The disclosure will now be described by a detailed description of several embodiments in order to show how the anti-scattering structure presented in this invention is able to solve the aforementioned problems. It is clear that other embodiments can be configured according to the knowledge of persons skilled in the art without departing from the true technical teaching of the present disclosure, the claimed disclosure being limited only by the terms of the appended claims.

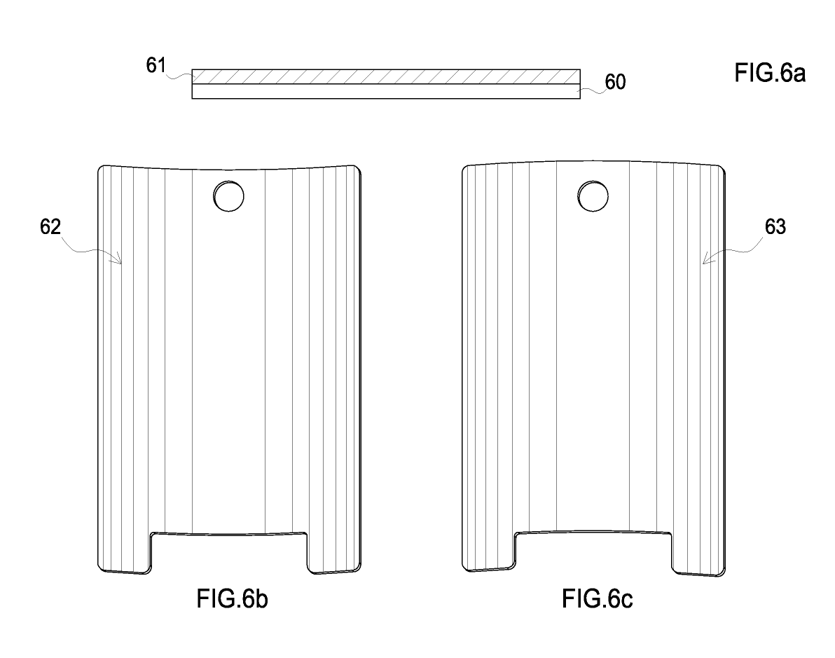

Please refer to FIG. 6a, which illustrates the side view of the structure of the first embodiment in accordance with the present invention. The anti-scattering layer 61 is formed on top of a substrate 60 by wet-coating a layer of urea-based polymer, following by thermo-curing the coated substrate. The substrate 60 has the freedom to have a contoured surface with a geometric shape selected from a group consisting of a flat shape, a curved shape, an uneven shape, an irregular shape, an engraved shape, and a combination thereof. After thermo-curing, the top of the anti-scattering layer 61 is hardened due to cross-linking of the polymer chains by heat and hence the anti-scattering layer has a sturdy appeal, the anti-scattering film formed. FIGS. 6b and 6c reveal one of the possible applications with the presented anti-scattering structure, wherein a phone back cover 62 illustrates the front view of the structure of a curved phone back cover; a phone back cover 63 illustrates the back top view of the structure of a curved phone back cover.

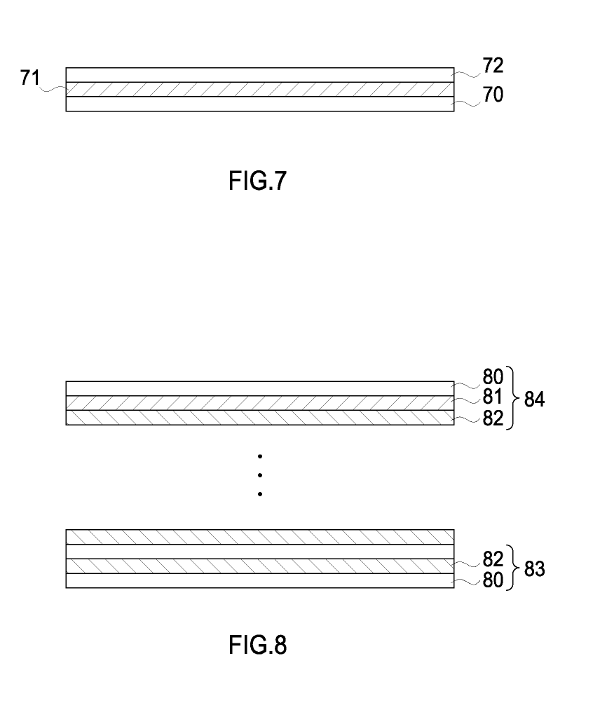

Please refer to FIG. 7, which illustrates the side view of the structure of the second embodiment in accordance with the present invention. An ink layer 71 is formed on top of a substrate 70 by spray printing, screen printing, transfer printing, inkjet printing, plating and a combination thereof. The substrate 70 has a surface with a geometric shape selected from a group consisting of a flat shape, a curved shape, an uneven shape, an irregular shape, an engraved shape, and a combination thereof. After the ink film is formed, an anti-scattering film 72 is formed on top of the ink layer 71 by wet-coating a layer of urea-based polymer, following by thermo-curing. After thermo-curing, the top of the anti-scattering layer 72 is hardened due to cross-linking of the polymer chains by heat and hence the anti-scattering layer 72 has a sturdy appeal with desired colors and graphical design.

Please refer to FIG. 8, which illustrates the side view of the structure of the third embodiment in accordance with the present invention. A plurality of layers of the anti-scattering structure is formed by stacking up the disclosure in embodiment one 83, embodiment two 84 and a combination thereof which consists of a substrate 80, an anti-scattering structure 82 and an ink film 81.

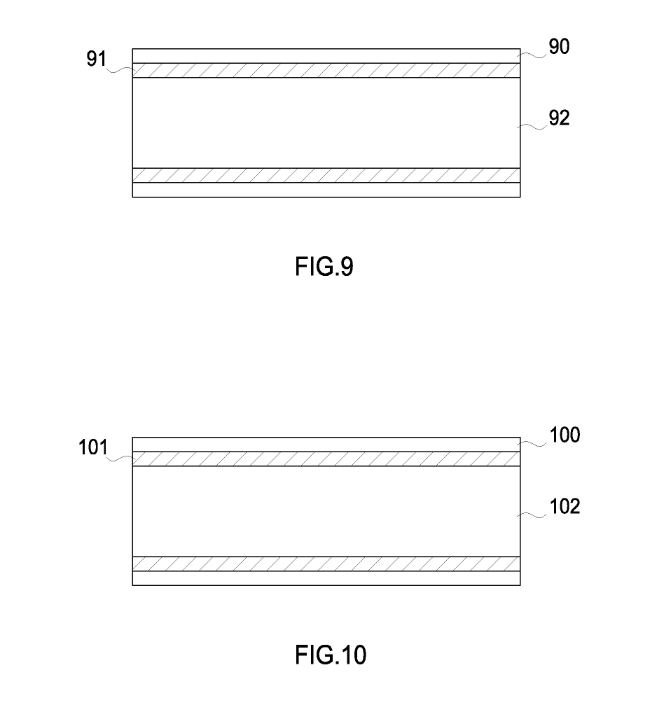

Please refer to FIG. 9, which illustrates the side of the structure of the fourth embodiments in accordance with the present invention. A vacuumed space 92 is between at least two layers of the anti-scattering structure which are disclosed in embodiment one, embodiment two and a combination thereof.

Please refer to FIG. 10, which illustrates the side of the structure of the fifth embodiments in accordance with the present invention. At least one of a material layer 102 is between at least two layer of the anti-scattering structure which are disclosed in embodiment one, embodiment two and a combination thereof. The said material is a ultra-violet ray absorbing material, a sound absorbing material, a heat absorbing material, shock absorbing material and a combination thereof.

With the disclosed anti-scattering structure, the cost of providing an anti-scattering structure on a substrate is greatly reduced because of many additional processes are no longer needed such as trimming the film into required size. It is much simpler to store and to transport the polymer instead of store and transport the conventional anti-scattering film in the autoclave with monitored pressure. The defect rate is greatly reduced with the proposed anti-scattering structure as it is able to laminate the substrate without trapped air. Hence, the geometric shape of the substrate no longer poses as a limitation. Designs with ergonomics can be implemented to enhance the user experience and to reduce the possible occupational health risks caused by poor ergonomics. Furthermore, the thickness of the proposed structure is much slimmer comparing to the conventional anti-scattering film, it is possible to further slim down the design of the product, particularly the products with precision electronics design.

While the disclosure has been described in terms of what are presently considered to be the most practical and preferred embodiments, it is to be understood that the disclosure need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore, the above description and illustration should not be taken as limiting the scope of the present disclosure which is defined by the appended claims.

What is claimed is:

1. An anti-scattering structure, comprising:
a substrate having a first surface; and
a polymer layer of a urea as an anti-scattering layer formed on the first surface.

2. The anti-scattering structure according to claim 1, further comprising a layer of an ink formed between the first surface and the polymer layer.

3. The anti-scattering structure according to claim 1, wherein the substrate includes a silicon-based material.

4. The anti-scattering structure according to claim 1, wherein the substrate is selected from one of an opaque substrate, a translucent substrate and a transparent substrate.

5. The anti-scattering structure according to claim 1, wherein the first surface has a geometric shape selected from a group consisting of a flat shape, a curved shape, an uneven shape, an irregular shape, an engraved shape and a combination thereof

6. The anti-scattering structure according to claim 2, wherein the ink is selected from a group consisting of a Polyvinyl Chloride-based ink, an Acrylonitrile Butadiene Styrene-based ink, an Acrylic-based ink and a combination thereof

7. The anti-scattering structure according to claim 1, wherein the polymer is a waterborne polymer, a solvent-based polymer and a combination thereof

8. An anti-scattering structure, comprising:
a substrate having a first surface;
an ink film formed on the first surface; and
an anti-scattering film including a urea polymer formed on the ink film.

9. The anti-scattering structure according to claim 7, wherein the ink has a color in black, white, silver, gold, red, green, blue, yellow and a combination thereof

10. An anti-scattering structure, comprising:
a first substrate;
a second substrate; and
an anti-scattering layer including a urea polymer formed between the first substrate and second substrate.

11. The anti-scattering structure according to claim 10, wherein the coating layers further comprising a layer of an ink formed between the substrate and the anti-scattering film.

12. An anti-scattering laminated structure, comprising:
a plurality of coating layers which are successively formed, each of which coating layers comprises:
a substrate; and
a urea polymer film as an anti-scattering film and coated on the substrate.

13. The anti-scattering structure according to claim 12, wherein the coating layers further comprising a layer of an ink formed between the substrate and the polymer film.

14. The anti-scattering structure according to claim 12, further comprising a layer of vacuum formed between the coating layers.

15. The anti-scattering structure according to claim 12, further comprising a layer of material formed between the coating layers.

16. The anti-scattering structure according to claim 12, wherein the material is selected from a group consisting of a heat absorbing material, a UV light absorbing material, a shock absorbing material, a sound absorbing material and a combination thereof.
